(19) United States
(12) Patent Application Publication
(10) Pub. No.: US 2002/0073237 A1
(43) Pub. Date: Jun. 13, 2002

(54) Methods of managing data over a networked system of computers

(76) Inventor: Nancy Fox George, Towson, MD (US)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/984,837

(22) Filed: Oct. 31, 2001

Related U.S. Application Data
(63) Continuation-in-part of application No. 09/627,232, filed on Jul. 27, 2000.

(51) Int. Cl. G06F 15/16

(52) U.S. Cl. 709/246

(57) ABSTRACT

A method of managing data over a networked system of computers includes the steps of gathering compliance data from at least one compliance data source and modifying at least a portion of the compliance data in order to create modified compliance data. The method also includes the step of displaying the modified compliance data to a user. Moreover, the step of displaying the modified compliance data includes the step of generating a first list of the modified compliance data, in which the first list includes at least one portion of a regulation. The step of displaying the modified compliance data also includes the step of generating a second list of the modified compliance data, in which the second list includes at least one requirement for complying with the at least one portion of the regulation.

The present application is a Continuation-in-Part of U.S. patent application No. 09/627,232, entitled “Compliance Data Management Systems and Methods,” the disclosure of which is incorporated herein by reference in its entirety.

### BACKGROUND OF THE INVENTION

1. Field of the Invention

The present invention relates generally to the field of data management over a computer network. More specifically, the invention is directed towards methods of managing compliance data over a networked system of computers, such as over the Internet.

2. Description of Related Art

Referring to FIG. 1, some known general computer systems may comprise a processor 101, a central processing unit (“CPU”) 103, and a memory section 104, in which processor 101 may comprise an input/output (“I/O”) section 102. I/O section 102 may be connected to a keyboard 105, a display unit 106, a disk storage unit 109, and a CD-ROM drive unit 107. CD-ROM unit 107 may read a CD-ROM medium 108, which may contain programs and data 110. In such known computer systems, processor 101 may be connected to the Internet via a connection 120. When processor 101 is connected to the Internet, a user may access public data via a World Wide Web (“WWW”) interface or browser. Web-sites on the Internet, which may comprise one or more web-pages, may be accessed and viewed using any known web interface or web browser.

Compliance data may be defined as any data related to a compliance authority's regulations, e.g., rules or suggestions established by any government, government agency, government administration, national or international body, or the like. Moreover, web-pages may contain compliance data related to a particular compliance authority regulation. For example, data related to the particular regulation may include data related to a source(s) of the regulation, i.e., the compliance authority or compliance authorities which established the regulation, precedential decisions interpreting the regulation, inspector guidelines for the regulation, reasons for the existence of the regulation, and the like. Data related to the particular regulation also may include requirements for complying with the regulation, such as data related to the source of the requirement for complying with the regulation, precedential decisions interpreting the requirement, inspector guidelines for the requirement, reasons for the existence of the requirement, and the like. Nevertheless, because compliance data may be generated by various compliance authorities, and also may be located in a plurality of locations, e.g., a plurality of remote web-pages or web-sites on the Internet, it may be difficult for a user to locate all, substantially all, or most of the compliance data related to a particular regulation. Moreover, even when the user is able to locate all, substantially all, or most of the data related to the particular regulation, the user may have to manually filter the compliance data in order to locate those portions of the compliance data which the user desires.

### SUMMARY OF THE INVENTION

Therefore, a need has arisen for methods of managing data over a networked system of computers that overcome these and other shortcomings of the related art. A technical advantage of the present invention is that all, substantially all, or most of the compliance data related to a particular regulation may be gathered from a source or a plurality of sources of compliance data. Moreover, the compliance data may be modified, and the modified compliance data may be displayed to a user. For example, the modified compliance data may be displayed as at least two lists, in which the first list may include at least a portion of the text of the regulation, and the second list may include at least one requirement for complying with the regulation. Another technical advantage of the present invention is that a user may access data related to a source or sources of the regulation, precedential decisions interpreting the regulation, inspector guidelines for the regulation, reasons for the existence of the regulation, and the like. For example, the user may access such data by selecting or enabling, e.g., by clicking on a mouse button, a hyperlink, which may be included in the first list. Yet another technical advantage of the present invention is that a user may access data related to a source or sources of the requirement for complying with the regulation, precedential decisions interpreting the requirement, inspector guidelines for the requirement, reasons for the existence of the requirement, and the like. For example, the user may access such data by selecting or enabling, e.g., by clicking on a mouse button, a hyperlink, which may be included in the second list.

In an embodiment of the present invention, a method of managing data over a networked system of computers is described. The method comprises the steps of gathering compliance data from at least one compliance data source and modifying at least a portion of the compliance data in order to create modified compliance data. The method also comprises the step of displaying the modified compliance data to a user. Moreover, the step of displaying the modified compliance data comprises the step of generating a first list of the modified compliance data, in which the first list comprises at least one portion of at least one regulation. The step of displaying the modified compliance data also comprises the step of generating a second list of the modified compliance data, in which the second list comprises at least one requirement for complying with the at least one portion of the regulation.

Other objects, features, and advantages will be apparent to persons of ordinary skill in the art in view of the following detailed description of the invention and the accompanying drawings.

### BRIEF DESCRIPTION OF THE DRAWINGS

For a more complete understanding of the present invention, needs satisfied thereby, and the features and advantages thereof, reference now is made to the following descriptions taken in connection with the accompanying drawings.

FIG. 1 is a schematic of a known computer system suitable for use in embodiments of the present invention.

FIG. 2 is a schematic of a data management system according to an embodiment of the present invention.

FIG. 3 is a flow chart of a method of managing information over a networked system of computers according to an embodiment of the present invention.

FIG. 4 is a schematic depicting an organization of the data management system of FIG. 2 according to an embodiment of the present invention.

FIG. 5 is a schematic of a compliance data classification scheme according to an embodiment of the present invention.

FIG. 6 is a schematic of a presentation scheme according to an embodiment of the present invention.

FIG. 7 is an example of a first list and a second list displayed on a display unit.

### DETAILED DESCRIPTION OF PREFERRED EMBODIMENTS

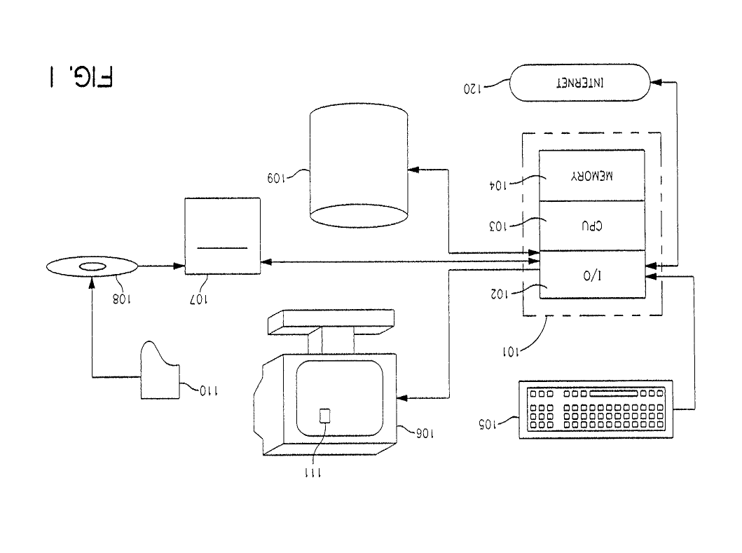

Preferred embodiments of the present invention and their advantages may be understood by referring to FIGS. 1-7, like numerals being used for like corresponding parts in the various drawings.

Compliance data may be defined as any data related to a compliance authority's regulations, e.g., rules or suggestions established by any government, government agency, government administration, national or international body, or the like. For example, the Food and Drug Administration (“FDA”) may have a number of regulations which may be found at www.fda.gov. Similarly, the U.S. Environmental Protection Agency (“EPA”), may have a number of regulations which may be found at www.epa.gov/epahome/lawreg.htm.

Referring to FIG. 1, a general computer system may comprise processor 101, central processing unit (“CPU”) 103, and memory section 104, in which processor 101 may comprise an input/output (“I/O”) section 102. I/O section 102 may be connected to keyboard 105, display unit 106, disk storage unit 109, and CD-ROM drive unit 107. CD-ROM unit 107 may read a CD-ROM medium 108, which may contain programs and data 110. In such known computer systems, processor 101 may be connected to the Internet via connection 120. When processor 101 is connected to the Internet, a user may access public data via a World Wide Web (“WWW”) interface. Web-sites on the Internet, which may comprise one or more web-pages, may be accessed and viewed using any known web interface or web browser.

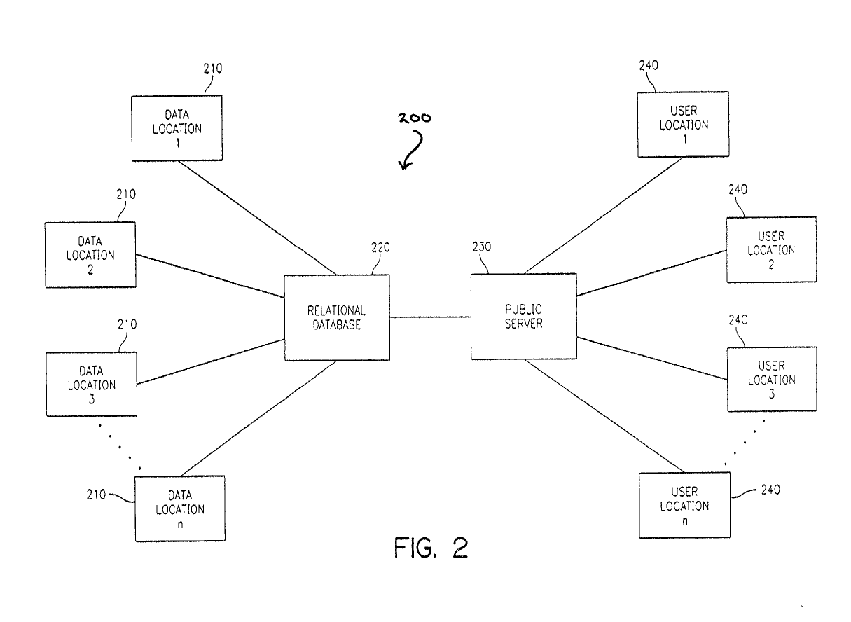

Referring to FIG. 2, a data management system 200 is described. Data management system 200 may comprise at least one data location 210 on a communications network, e.g., web-pages, web-sites, or the like, a database 220, a public data server 230, e.g., an Internet service provider (“ISP”). Moreover, at least one user may access the network at a plurality of locations 240 via a remote communications device, e.g., via a personal computer, a web phone, a handheld data organizer, or the like, which may be connected to the network via a modem, an Ethernet connection, a wireless connection, or the like. In operation, compliance data may be generated by at least one compliance data source, e.g., the compliance authority, and the compliance data may be published at one or more locations 210. The published compliance data may be gathered and the gathered compliance data subsequently may be modified, classified, and stored within database 220, which may be implemented on a workstation or a computer. The modified compliance data subsequently may be transferred to public data server 230 and may be accessed by the at least one user at any location 240 via the remote communication device.

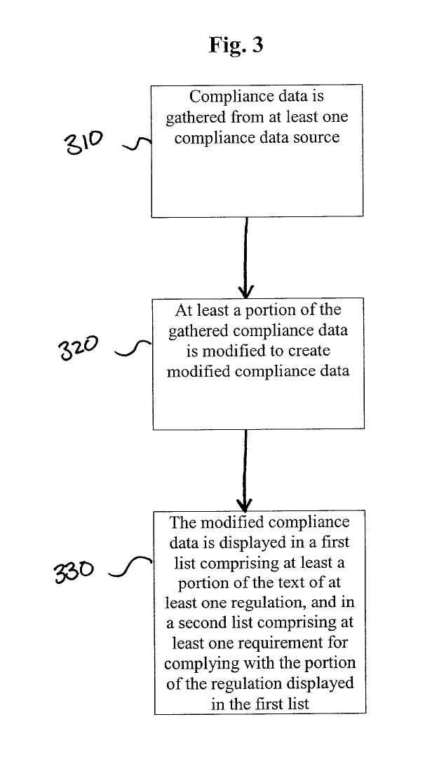

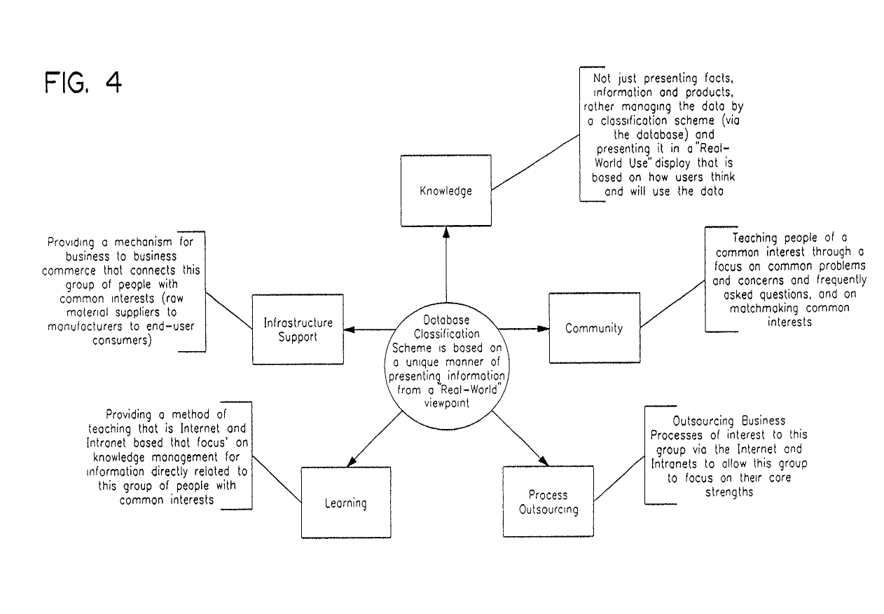

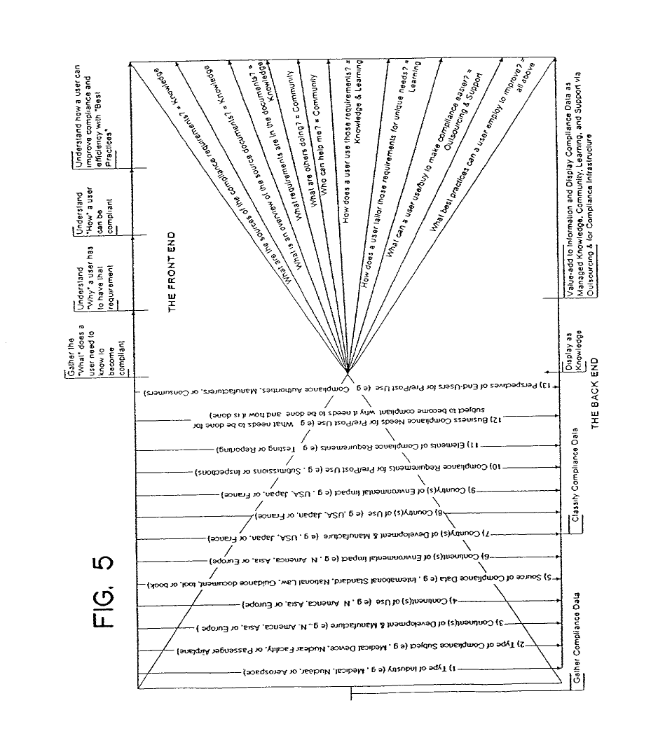

Referring to FIG. 3, a method of compliance data management according to an embodiment of the present invention is described. For example, compliance data may be generated by at least one compliance data source, e.g., the compliance authority, and may be published at the at least one location 210, e.g., web-pages, web-sites, or the like. For example, the compliance data may be generated by the FDA and may be published at www.fda.gov/. In step 310, the compliance data may be gathered from the at least one source by accessing at least one data location 210. Step 310 may be performed manually or may be performed automatically by a computer routine or a computer application. Manually gathering the compliance data may comprise the step of scanning printed compliance documents into a digital or other machine readable and storable format. In step 320, at least a portion of the gathered compliance data may be modified. For example, in an embodiment, all of the gathered compliance data may be modified. Modification of the compliance data also may include supplementing the compliance data with organizational or other cataloging data, e.g., data used to organize the compliance data into specific categories (shown in FIG. 4), formatting the compliance data, e.g., changing the display arrangement or appearance, or changing the specified code format of the data, or removing undesired information from the compliance data, or any combinations thereof. Changing the display arrangement of the compliance data may include selecting a portion of the compliance data and displaying the selected portion of the compliance data. Moreover, changing the appearance of the compliance data may include selecting a portion of the compliance data, rearranging the words within the selected portion of the compliance data, and displaying the rearranged portion of the compliance data. Rearranging the selected portion of the compliance data also may include removing some of the words of the selected portion of the compliance data. Such modifications may be implemented by a computer application, such as a text editor or a word processor. In each of the above-described embodiments, the modified compliance data subsequently may be classified (shown in FIG. 5) and stored in database 220, such as a relational database. Database 200 may be implemented using a structured query language (“SQL”) or any programmable database language or application.

In an embodiment, when the modified compliance data is stored in database 220, the modified compliance data may be transferred to public data server 230, such that the modified compliance data may be accessed by at least one user at location 240 via the remote communication device. For example, the modified compliance data stored in database 220 may be transferred at predetermined time intervals, e.g., may be transferred hourly, daily, or the like, to public data server 230. As such, modified compliance data may be entered or changed within database 220 without directly interacting with public data server 230. Moreover, database 220 and public data server 230 may be synchronized, such that public data server 230 may maintain accurate and current modified compliance data. Such synchronization may be performed manually or may be automated via software. Database 220 also may be publicly inaccessible, e.g., database 220 may be password protected, i.e., a user may have to enter an acceptable password before the user may access database 220. For example, database 220 may be password protected at the administrator, management, and data entry levels via software.

In another embodiment, unauthorized users attempting to communicate with public data server 230 via the remote communication device at location 240 may be denied access, such that unauthorized users may be unable to download, print, or receive at least a portion of the displayed modified compliance data. An unauthorized user may become an authorized user by registering, which may or may not include a registration fee.

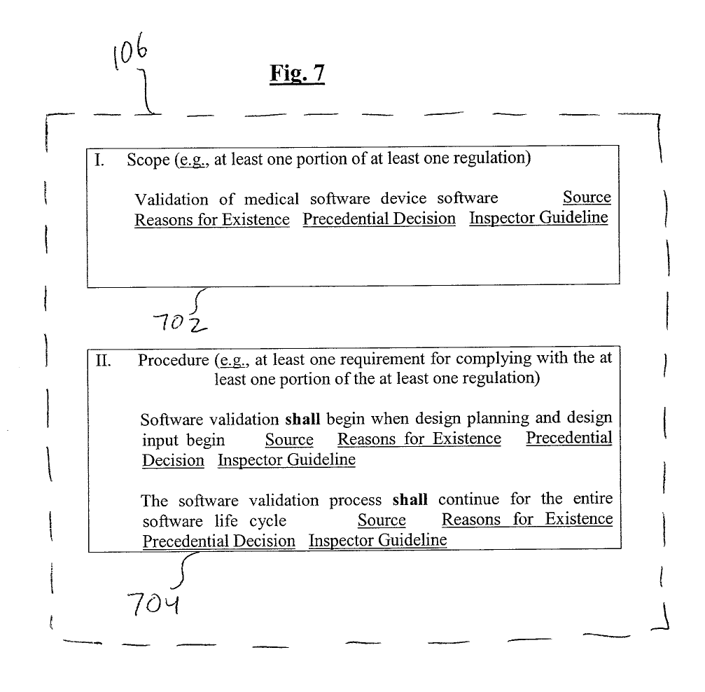

In step 330, the method also may comprise displaying the modified compliance data to the at least one user. Referring to FIG. 7, the step of displaying may comprise the step of generating a first list 702 of the modified compliance data, and first list 702 may comprise at least a portion of the text of at least one regulation. In an embodiment, the step of displaying may comprise the step of highlighting at least one word, phrase, or both in first list 702. The term “highlighting” is defined as selecting at least one word or at least one phrase from the list and displaying those selected word(s) or phrase(s) in a mode which is different, e.g., noticeably different, from the display mode of the other words or phrases in the list. For example, the highlighted word(s) or phrase(s) may be those of word(s) or phrase(s) which may be of importance in understanding the regulation. The step of displaying also may comprise the step of generating a second list 704 of the modified compliance data, and second list 704 may comprise at least one requirement for complying with those portions of the at least one regulation displayed in first list 702. In an embodiment, the step of displaying may comprise the step of highlighting at least one word, phrase, or both in second list 704. Moreover, the step of generating first list 702 may include the steps of querying the at least one user and generating first list 702 based on the query. When first list 702 is generated based on the query of the at least one user, the step of generating second list 704 may include the step of generating second list 704 based on first list 702. For example, when the user selects a regulation or a type of regulation for display in first list 702, second list 704 may be generated and may display at least one requirement for complying with the selected regulation.

In any of the above-described embodiments, the step of displaying further may comprise the step of providing means for accessing regulatory data related to those portions of the regulation displayed in first list 702. Such regulatory data may include any data related to a source(s) of the regulation, i.e., the compliance authority or compliance authorities which established the regulation, precedential decisions interpreting the regulation, inspector guidelines for the regulation, reasons for the existence of the regulation, or the like, or any combinations thereof. For example, the means for accessing the regulatory data may comprise a hyperlink, such that when the user selects or enables, e.g., clicks on, the hyperlink, the user may be transferred to a web-site displaying the desired regulatory data.

In any of the above-described embodiments, the step of displaying also may comprise the step of providing means for accessing guidance data related to those requirements displayed in second list 704 for complying with the regulation displayed in first list 702. Such regulatory data may include any data related to the source(s) of the at least one requirement for complying with the regulation, precedential decisions interpreting the requirement, inspector guidelines for the requirement, reasons for the existence of the requirement, or the like, or combinations thereof. For example, the means for accessing the guidance data may comprise a hyperlink, such that when the user clicks on the hyperlink, the user may be transferred to a website displaying the desired guidance data.

In an embodiment, displaying the modified compliance data also may comprise the step of customizing the modified compliance data. For example, the displayed compliance data may be customized according to an individual user's preferences, e.g., display options, such as a preferred presentation format or an immediate display of frequently used modified compliance data. The user may configure the display preferences based on user group types or through the user's own submission and interaction with public data server 230. User preferences also may be set by a computer application which may monitor user traffic, log patterns, usage history, or the like, or combinations thereof.

Referring to FIG. 4, an example of how the compliance data may be organized and presented to users is described. In an embodiment, compliance data may be organized and presented to users based on at least one of the following elements:

1. Classification of Compliance Data (Knowledge): Managing the data by a classification scheme via database 220 and presenting the classified data in a “real-world” viewpoint that may be directed towards anticipated uses and business applications of the compliance data. For example, compliance requirements for selling, producing, disposing, or importing a product, e.g., a drug, a medical device, any manufactured product, or the like, may be displayed.

2. Common Areas of Compliance Usage (Community): Teaching users of a common interest in a particular type of regulation through a focus on common problems, concerns, interests, and frequently asked questions. For example, users may interact and network via an Internet chat session.

3. Pooled Compliance Resources (Process Outsourcing): Outsourcing business processes of interest to a group via the Internet or an intranet in order to allow a group of users to focus on their specific needs. Compliance tools or solutions may be provided to a common task, such as bringing a drug to market, which may be accessed from anywhere and used by all users interested in performing the common task.

4. Improved Compliance (Learning): Teaching users about compliance. Specifically, teaching users how to comply with regulations or to how to improve compliance implementation by providing tutorials that are Internet and intranet based and focus on compliance management directly related to a group of users with common interests. For example, teaching users about the reasons for the existence of a specific requirement.

5. Business Compliance (Infrastructure Support): Focusing on business applications of compliance data. Specifically, providing a mechanism which allows businesses and consumers to communicate with each other. For example, suppliers who want to sell to a market may be allowed to advertise their products or sell their products, or both. In addition, addressing compliance issues related to business-to-business-to-consumer commerce which connects a group of users with common interests, for example, connecting raw material suppliers to manufacturers to end-user consumers.

Referring to FIG. 5, a compliance data classification scheme is described. After the compliance data is gathered and modified, the modified compliance data may be classified according a classification scheme. For example, the classification scheme may comprise at least thirteen categories for organizing the modified compliance data. Some of the possible categories for classifying the modified compliance data are described as follows: 1) Type of industry, e.g., medical, nuclear, and aerospace, in which the compliance data is applicable; 2) Type of compliance subject, e.g., medical device, nuclear facility, or passenger airplane, that the compliance data addresses; 3) Continent(s) where the compliance subject is developed and manufactured, e.g., North America, Asia, Europe, or combinations thereof; 4) Continent(s) where the compliance subject is used; 5) Source of the compliance data, e.g., international standard, national law, guidance document, tool, book, or the like; 6) Continent(s) of environmental impact of the compliance subject; 7) Countries where the compliance subject is developed and manufactured, e.g., United States, Japan, or both; 8) Countries where compliance subject is used; 9) Countries of environmental impact of the compliance subject; 10) Compliance requirements for subject prior to, during, and after the use of the subject, e g., submissions to have subject approved prior to use or inspections of subject during operation; 11) Common elements of compliance requirements for subject, e.g., types of testing or reporting; 12) Business compliance needs for before, during, and after use of subject, e g., the answers to question, such as what needs to be done for subject to become compliant, why it needs to be done, and how it may be done; 13) Perspectives of the end-users for before, during, and after use of subject, e.g., how the data is viewed by compliance authorities, manufacturers, and consumers.

The above categories address the anticipated uses of compliance data and are applicable to most or all types of compliance data. Further, through the implementation of the classification scheme, users may more readily find answers to a wide variety of questions arising from the applications of compliance data. For example, the invention may provide a centralized source for users to acquire answers to at least the questions listed on the right half of FIG. 5. Specifically, in view of the five general categorical elements described above, i.e., those labeled Knowledge, Community, Learning, Process Outsourcing, and Infrastructure Support, the invention may provide answers to knowledge type users questions, such as, what are the sources of compliance requirements, what is an overview of the source documents, and what requirements are in the documents. Further, the invention may provide the data to answer community type user questions, such as, what are others doing and who may help, e.g., business or government services. Moreover, the invention may manage data addressing learning type user questions, such as, how does a user use those requirements and how does a user tailor those requirements for unique needs. In addition, the invention may manage data to answer support type questions, such as, what may a user use or buy to make compliance easier and what best practices can a user employ to improve compliance.

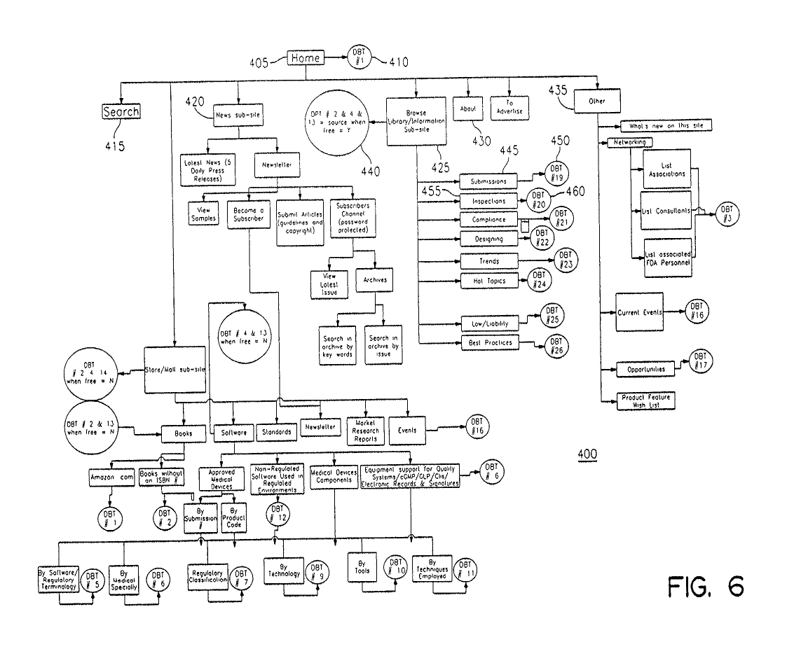

Referring to FIG. 6, an example of a hierarchical presentation scheme including a data presentation template 400 is described. Template 400 may be applicable to a web-site comprising a plurality of web-pages on public data server 230. Nevertheless, it will be understood by those of ordinary skill in the art that a web-site merely is an example of a plurality of possible implementations of template 400, and that the present invention may be implemented on any hierarchical information distribution system.

The modified compliance data, which is to be displayed or presented on the website, may be stored within database 220 using tables, which may be referred to as database tables (“DBTs”). The DBTs may be linked to or accessed by one or more web-pages and vice versa.

The modified compliance data may be displayed according to viewpoints relating to a user's experience in compliance requirements. For example, a user may choose to perform a search for information which they desire, or may view all the possible selections before conducting a search.

Home 405 may be a starting point or homepage for users to access public data server 230. Home 405 may be linked to data contained within database table 410, e.g., DBT#1. Home 405 also provides links to other web-pages, such as web-pages 415, 420, 425, 430, and 435, which may contain information and data regarding particular compliance data applications. In an embodiment, web-pages 415 may contain a tool for searching the entire web-site, and web-pages 420 may contain information regarding web-site news and links to specific sub-topics, such as becoming a subscriber of the web-site or news. Web-site 425 is linked to data contained within DBT#2 and DBT#4 at link 440. Web-site 425 also may be linked to web-pages related to specific categories of the modified compliance data, such as the following topics: required or voluntary submissions, inspections, compliance, designing, trends, hot topics, law/liability, and best practices. Each of these web-pages may have a link to a DBT. For example, web-pages 445, which relates to submissions information, may be linked to table 450, e.g., DBT#19, and web-pages 455, which relates to inspections information, may be linked to table 460, e.g., DBT#20. For example, table 460 may contain fields associated with sub-topics such as: inspections to recognized standards, general inspections, ‘for cause’ inspections, routine surveillance inspections, pre-market inspections, quality systems inspections techniques, hazard analysis critical control points, guidelines for inspections, and the like.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. A method of managing data over a networked system of computers comprising the steps of:
gathering compliance data from at least one compliance data source;
modifying at least a portion of said compliance data to create modified compliance data;
electronically providing said modified compliance data to a remote communication device; and
displaying said modified compliance data to at least one user, wherein the step of displaying comprises the steps of:
generating a first list of said modified compliance data, wherein said first list comprises at least one portion of at least one regulation; and
generating a second list of said modified compliance data, wherein said second list comprises at least one requirement for complying with said at least one portion of said regulation.

2. The method of claim 1, wherein the step of generating said first list comprises the step of querying said at least one user, wherein said first list is generated based on said query.

3. The method of claim 2, wherein said second list is generated based on said first list.

4. The method of claim 1, wherein the step of generating said first list comprises the step of providing means for accessing regulatory data for said at least one portion of said regulation.

5. The method of claim 4, wherein said regulatory data comprises at least one source of said at least one portion of said regulation.

6. The method of claim 4, wherein said regulatory data comprises at least one reason for the existence of said at least one portion of said regulation.

7. The method of claim 4, wherein said regulatory data comprises at least one precedential decision interpreting said at least one portion of said regulation.

8. The method of claim 4, wherein said regulatory data comprises at least one inspector guideline for said at least one portion of said regulation.

9. The method of claim 1, wherein the step of generating said second list comprises the step of providing means for accessing guidance data for complying with said at least one requirement.

10. The method of claim 9, wherein said guidance data comprises at least one source of said at least one requirement.

11. The method of claim 9, wherein said guidance data comprises at least one reason for the existence of said at least one requirement.

12. The method of claim 9, wherein said guidance data comprises at least one precedential decision interpreting said at least one requirement.

13. The method of claim 9, wherein said guidance data comprises at least one inspector guideline for said at least one requirement.

14. The method of claim 1, wherein the step of generating said first list comprises the step of providing means for accessing regulatory data for said at least one portion of said regulation, and the step of generating said second list comprises the step of providing means for accessing guidance data for complying with said at least one requirement.

15. The method of claim 14, wherein said regulatory data comprises at least one source of said at least one portion of said regulation and said guidance data comprises at least one source of said at least one requirement.

16. The method of claim 15, wherein said regulatory data further comprises at least one reason for the existence of said at least one portion of said regulation and said guidance data further comprises at least one reason for the existence of said at least one requirement.

17. The method of claim 16, wherein said regulatory data further comprises at least one precedential decision interpreting said at least one portion of said regulation and said guidance data further comprises at least one precedential decision interpreting said at least one requirement.

18. The method of claim 17, wherein said regulatory data further comprises at least one precedential decision interpreting said at least one portion of said regulation and said guidance data further comprises at least one precedential decision interpreting said at least one requirement.

19. The method of claim 4, wherein said means for accessing regulatory data comprises a hyperlink.

20. The method of claim 9, wherein said means for accessing guidance data comprises a hyperlink.

21. The method of claim 14, wherein said means for accessing regulatory data comprises a hyperlink.

22. The method of claim 14, wherein said means for accessing guidance data comprises a hyperlink.

23. The method of claim 4, wherein the step of displaying further comprises the step of highlighting at least one word in said first list.

24. The method of claim 9, wherein the step of displaying further comprises the step of highlighting at least one word in said second list.

25. The method of claim 14, wherein the step of displaying further comprises the step of highlighting at least one word in said first list and highlighting at least one word in said second list.

26. The method of claim 4, wherein the step of modifying at least a portion of said compliance data comprises the step of supplementing and formatting at least portion of said compliance data to create said modified compliance data.

27. The method of claim 9, wherein the step of modifying at least a portion of said compliance data comprises the step of supplementing and formatting at least portion of said compliance data to create said modified compliance data.

28. The method of claim 14, wherein the step of modifying at least a portion of said compliance data comprises the step of supplementing and formatting at least portion of said compliance data to create said modified compliance data.

29. The method of claim 28, wherein the step of modifying at least a portion of said compliance data comprises the step of storing said modified compliance data within a database.

30. The method of claim 29, wherein the step of modifying at least a portion of said compliance data further comprises the step of classifying said modified compliance data within said database based on a classification scheme relating to compliance data.

31. The method of claim 30, wherein the step of modifying at least a portion of said compliance data further comprises the step of transferring said modified compliance data from said database to a remote communication device via a data server.

32. The method of claim 1, wherein the step of gathering compliance data is performed manually.

33. The method of claim 1, wherein the step of gathering compliance data is performed by a computer program.

34. The method of claim 31, wherein the step of displaying further comprises the step of customizing said display.

35. The method of claim 34, wherein said user's preferences and needs are determined by a computer program which monitors user traffic, log patterns, and usage history.

36. The method of claim 1, wherein said compliance data is selected from the group consisting of government standards, government regulations, international standards, domestic standards, guidance documents, regulations, laws, data relating to compliance issues, or a combination thereof.

37. The method of claim 29, wherein said database is a password protected database and said data server is a public web server.

38. The method of claim 37, further comprising the step of synchronizing said modified compliance data stored in said publicly inaccessible database with said modified compliance data stored in said public web server.

39. The method of claim 38, further comprising the step of preventing said modified compliance data from being downloaded from said web server to an unauthorized remote communication device.

40. The method of claim 1, wherein the step of gathering compliance data comprises the step of uploading compliance data from a remote communication device.
